(19) United States
(12) Patent Application Publication
(10) Pub. No.: US 2019/0232540 A1
(43) Pub. Date: Aug. 1, 2019

(54) KEYBOARD INTEGRALLY FORMED BY INJECTION MOLDING, AND MOLD

(71) Applicant: Haibo JIANG, SHENZHEN (CN)

(72) Inventor: Haibo JIANG, SHENZHEN (CN)

(21) Appl. No.: 16/261,948

(22) Filed: Jan. 30, 2019

Related U.S. Application Data
(63) Continuation of application No. PCT/CN2017/095353, filed on Jul. 31, 2017.

(30) Foreign Application Priority Data
Aug. 15, 2016 (CN) 201620885577.X

(51) Int. Cl. B29C 45/16; B29C 45/26; H01H 11/00

(52) U.S. Cl. CPC B29C 45/162; B29L 2031/466; H01H 11/00; B29C 45/2681

(57) ABSTRACT

A keyboard with I-shaped key caps integrally formed by injection molding includes I-shaped key caps integrally formed, a printed circuit film, and a keyboard base plate for supporting the printed circuit film. A groove is provided on the hard sheet for flow guiding so as to achieve integral injection molding of a soft-rubber convex elastic switch body in the center of the inner side of the hard sheet. Hence, the soft-rubber convex elastic switch body is directly molded in the center of the hard sheet. In this way, during pressing, the soft-rubber convex elastic switch body can directly receive a pressing force transferred from the hard sheet, thereby achieving higher press accuracy. The disclosure solves the technical problem of injection molding/mold stripping of a traditional keyboard structure, so that a key surface, of the entire keyboard has small gaps and is pretty smooth.

### CROSS-REFERENCE TO RELATED APPLICATIONS

This application is a continuation of International Patent Application No. PCT/CN2017/095353 with a filing date of Jul. 31, 2017, designating the United States, now pending, and further claims priority to Chinese Patent Application No. 201620885577.X with a filing date of Aug. 15, 2016. The content of the aforementioned applications, including any intervening amendments thereto, are incorporated herein by reference.

### TECHNICAL FIELD

The disclosure relates to the technical field of computer keyboards, and particularly relates to a keyboard with I-shaped key caps integrally formed by injection molding and mold for integrally forming the I-shaped key caps integrally formed by injection molding.

### BACKGROUND OF THE PRESENT INVENTION

With the development of information industry a computer is increasingly and widely used. Whether a laptop or a desktop computer must have a computer keyboard. The existing keyboard has multiple parts, and generally consists of key caps, elastic silica gel switches, scissor feet, a printed circuit film and a keyboard base plate. With such a multi-part structure, the keyboard is high in production cost, various key caps are matched with corresponding elastic silica gel switches and scissor feet to be installed one by one, so assembling is troublesome. Furthermore, such a structure where single key cap is installed one by one difficultly makes the made keyboard thin, and thus a soft/hard rubber thin keyboard without the scissor feet and independent elastic silica gel switch correspondingly occurs. However, for an integrated key cap replacing, an independent elastic silica gel switch and a product meeting requirements produced by using a production process thereof, how to ensure press stability, press sensitivity and defamation recovery capability of the product key, reduce parts, decrease cost and become thinner is always a difficulty pursued by keyboard research staff. In view of this, development of a technology of designing a keyboard which is few in parts, low in cost, simple to assemble, good in press deformation recovery property, sensitive to press and convenient for injection molding becomes an urgent technical problem.

### SUMMARY OF PRESENT INVENTION

Aiming at the defects of the prior art, an objective of the present disclosure to provide a keyboard, which is low in cost, simple to assemble, good in press deformation recovery property, sensitive to press, convenient for injection molding and thin in molding, integrally formed by injection molding by providing a groove on a hard sheet.

In order to achieve the above objective, the technical solution of the present disclosure is as follow: a keyboard with I-shaped key caps integrally formed by injection molding comprises I-shaped key caps integrally formed, a printed circuit film located under the I-shaped key caps integrally formed and a keyboard base plate for supporting the printed circuit film; the I-shaped key caps are integrally formed from soft rubber and a plurality of hard sheets by integral injection molding, each hard sheet corresponds to one key unit; a concave body which does not penetrate through the hard sheet is formed in the center of the bottom surface of each hard sheet; a concave guide slot which does not penetrate through the hard sheet is formed on the edge of any side of the bottom surface of the hard sheet and the concave guide slot is communicated with the concave body; during injection molding with the soft rubber, soft rubber respectively forms a plurality of soft-rubber key surfaces, a plurality of soft-rubber key surface supporting bodies and a soft-rubber supporting body base; the upper and lower ends of the key surface supporting body are respectively connected with the soft-rubber key surface and a key base to form an integrated I-shaped soft-rubber entirety, and meanwhile, the soft rubber is injected into the concave body via the concave guide slot to form a soft-rubber convex elastic switch body; when the soft-rubber key surface on the key unit is pressed, a pressing force applied to the soft-rubber key surface acts on the hard sheet, the hard sheet transfers the pressing force to the soft-rubber convex elastic switch body, the soft-rubber supporting body is bent downward and vertically moves downward which makes the soft-rubber convex elastic switch body vertically moves downward until clicking and contacting a switching point of the corresponding switching circuit on the printed circuit film so that the switching circuit is closed and powered on; when the soft-rubber key surface of the key unit is released, deformations of the soft-rubber convex elastic switch body and the soft-rubber supporting body are simultaneously recovered, the soft-rubber convex elastic switch body is departed from the switching point of the corresponding switching circuit on the printed circuit film so that the switching circuit is disconnected, and the integrated I-shaped key cap is recovered to an original state.

The soft-rubber key surface extends outwardly around, all edges of the hard sheet to form a T-shaped surface, and forms the integrated I-shaped key cap together with the soft-rubber supporting body and the soft-rubber base by injection molding.

After assembling, a bottom surface of each part of the soft-rubber base is bonded with corresponding positions of the printed circuit film to form a whole body.

An edge at the bottom surface of the hard sheet is provided, with a downwardly protruded positioning ring matched with a positioning groove of a male mold for injection molding.

The soft-rubber convex elastic switch body is a cylinder which is integrally formed by injection molding and fitted to the concave body at the bottom surface of the hard sheet, and the tail end of the cylinder right corresponds to the switching point of the printed circuit film.

The hard sheet is a hard plastic sheet, or a metal sheet, or a glass sheet.

The soft rubber is a soft rubber material such as acrylate rubber, silica gel rubber, TPR rubber, or PVC rubber.

The present disclosure provides a mold for integrally forming I-shaped key caps integrally formed by injection molding, including a male mold and a female mold, the inner side surface at the bottom of the female mold is provided with a circle of concave groove, the male mold is provided with a key-unit injection molding boss the center of which is provided with an injection molding shrinkage hole, and a positioning groove for installation of the positioning ring of the hard sheet is formed on an edge at the key-unit injection molding boss.

The present disclosure provides a method for producing the I-shaped key caps integrally formed by injection molding. The device for realizing the method includes an injection machine, a male mold and a female mold. The method includes the following steps:

Step 1, during injection molding, all the hard sheets are correspondingly put into corresponding key-unit injection molding bosses on the male mold, and the positioning rings on the bottom surfaces of the hard sheets are inserted and positioned in the positioning grooves on the key-unit injection molding bosses;

Step 2, after the female mold is clamped on the male mold, soft rubber is injected into mold cavities, the soft rubber respectively forms a plurality of soft-rubber key surfaces, a plurality of soft-rubber key surface supporting bodies and a soft-rubber supporting body base in the mold: meanwhile, the soft rubber is injected into the injection molding shrinkage hole of the key-unit injection molding boss via the concave guide slot of the hard sheet, and the soft rubber in the injection molding shrinkage hole is bonded to the concave body at the hard sheet to form the soft-rubber convex elastic switch body;

Step 3, after the soft-rubber substance in the mold is solidified, the male mold and the female mold are opened, and the integrated key caps which have been molded are ejected out one by one through a mold thimble.

After the above structure and method are adopted, the present disclosure has the following advantages that:

1. A groove is provided on the hard sheet for flow guiding so as to achieve integral injection molding of a soft-rubber convex elastic switch body in the center of the inner side of the hard sheet, so that the soft-rubber convex elastic switch body is directly molded in the center of the hard sheet, in such a way, when in pressing, the soft-rubber convex elastic switch body can directly receive a pressing force transferred from the hard sheet; the soft-rubber convex elastic switch body is downwardly pressed to contact a switching point of a corresponding switching circuit on the printed circuit film so that the switching circuit is closed and powered on, in such a way, the pressing force transferred from the hard sheet can achieve higher press precision, trepanning on the hard sheet is avoided to perform integral injection molding of the soft-rubber convex elastic switch body, the pressing force is generated when transfer is performed via the soft-rubber press surface 11 to cause the center of the soft-rubber press surface 11 to be protruded and deformed and is poor in pressing force, and a problem that trepanning is traditionally performed in the center of the hard sheet to form the soft-rubber convex elastic switch body by means of injection molding and the soft-rubber convex elastic switch body receives the pressing force when in pressing to be upwardly transferred to the soft-rubber key surface to cause the center of the soft-rubber key surface to be protruded and unsmooth so as to influence hand feeling is also solved.

2. The present disclosure inventively is an injection molding structure of an integrated I-shaped key cap, the traditional hard material will not demould if being formed into an I-shaped key cap by means of injection molding, however, the soft-rubber injection molding I-shaped key cap of the present disclosure can smoothly demould utilizing deformation of soft rubber, thereby solving the problem of the traditional injection molding technology. Furthermore, the I-shaped key cap enables the soft-rubber key surfaces of the two key units to be extremely close to form small gaps, in such a way, the key surface of the whole keyboard is pretty smooth, and the shape of the product is more beautiful.

3. Most of the traditional keyboards adopt independent elastic silica gel switches to be bonded to the switching points of the printed circuit film, and keys formed using soft rubber are fixed and clamped by a key grid bracket in general. In the present disclosure, all of the bottom surfaces of various parts of the soft-rubber bottom base are bonded with the corresponding positions of the printed circuit film to form a whole body, which can take an effect of firm fixation, and meanwhile, the key grid bracket is saved, so that the product is fewer in parts, thinner in the whole thickness, lighter in weight, simpler to assemble and lower in cost.

4. In the present disclosure, an edge at the bottom surface of the hard sheet is provided with a downwardly protruded positioning, ring matched with the positioning groove of the injection molded male mold is provided on an edge at the bottom surface of the hard sheet, this positioning ring, on the one hand, can improve the precise positioning of the hard sheet when in injection molding, and on the other hand, this positioning ring is vertically downward along, with the soft-rubber convex elastic switch body when in pressing after the product is molded; when the soft-rubber convex elastic switch body moves to click and contact a switching point of a corresponding switching circuit on the printed circuit film, the circle of bottom of the positioning ring is abutted against the printed circuit film, so that the key caps can keep balance when being pressed to the bottom, thereby taking an effect of smoothly pressing, overcoming the problem that the traditional key is uneven and easy to waggle when in pressing and improving the press hand feeling and balance.

5. The soft-rubber supporting body has functions of supporting the hard sheet to prevent waggle and having an elasticity, and has water-proof and dustproof functions and a function of preventing light from being outwardly diffused.

6. The soft-rubber convex elastic switch body has not only a function of good press deformation recovery property but also a function of a switching point of the corresponding switching circuit on the printed circuit film, and the hard sheet makes the force received by the whole key balanced and steady; without structures such as scissor feet, the present disclosure is few in part, low in cost, and simple and convenient to assemble.

### DESCRIPTION OF THE DRAWINGS

FIG. 1 is a diagram of a local cross-sectional structure of a keyboard according to embodiments of the present disclosure;

FIG. 2 is a front view of a stereostructure of a key unit according to the present disclosure;

FIG. 3 is a back view of a stereostructure of a key unit according to the present disclosure;

FIG. 4 is a front exploded view of an injection molding stereostructure of one key unit according to the present disclosure;

FIG. 5 is a back exploded view of an injection molding stereostructure of one key unit according to the present disclosure; and

FIG. 6 is a back exploded view of an injection molding cross-sectional structure of one key unit according to the present disclosure.

### DETAILED DESCRIPTION OF PREFERRED EMBODIMENTS

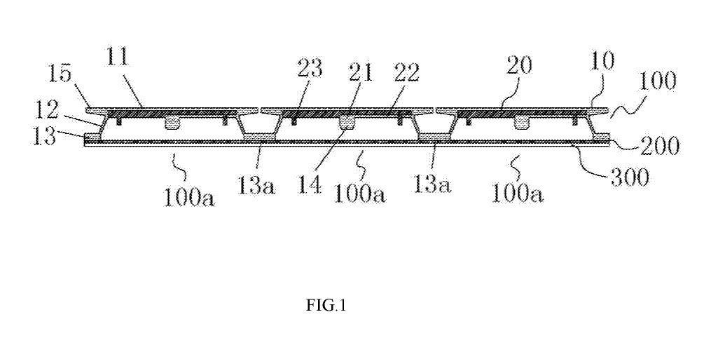

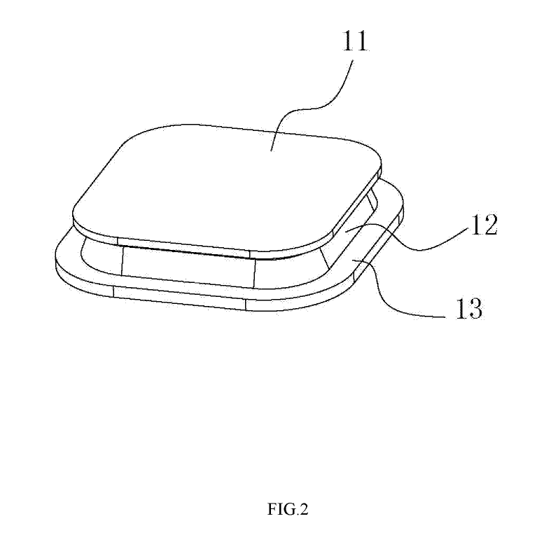

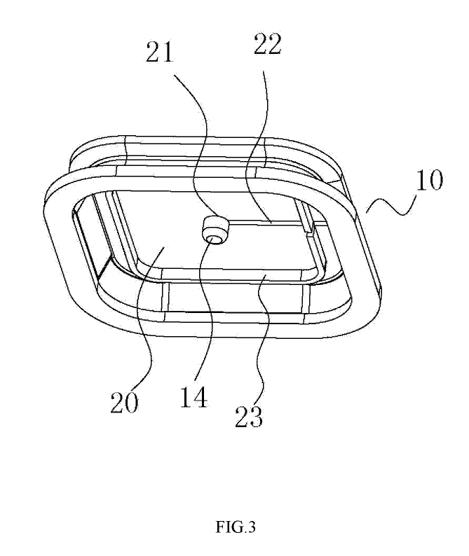

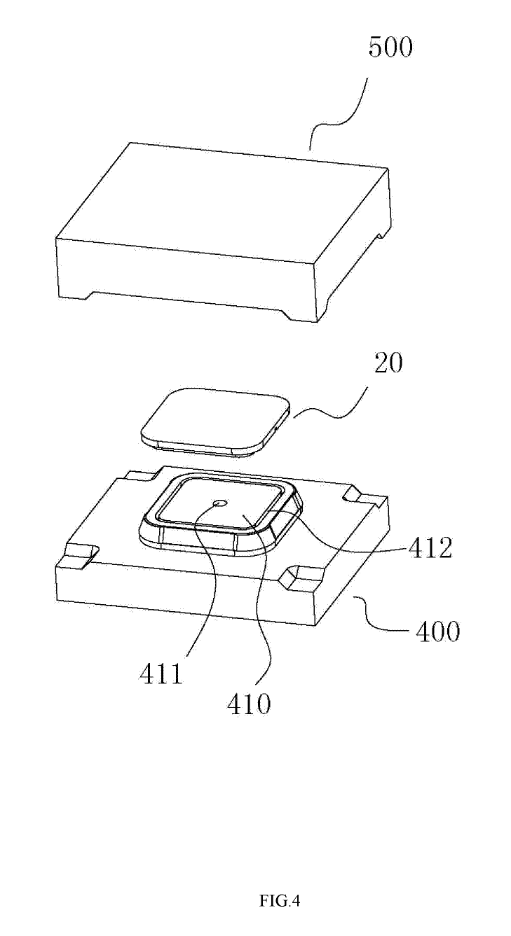

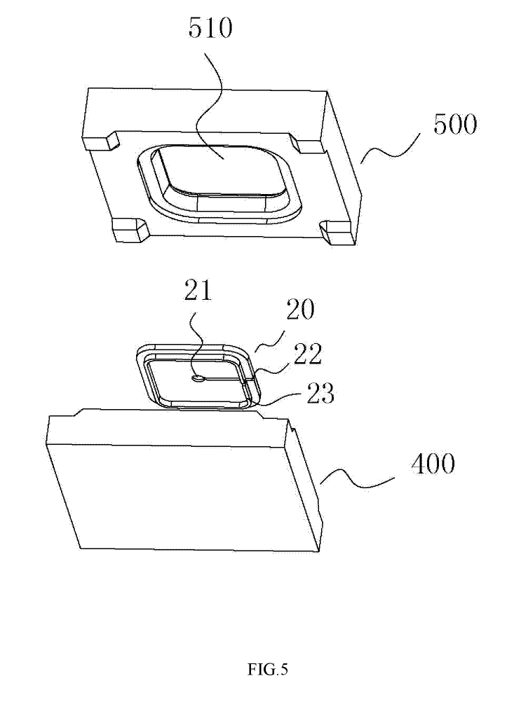

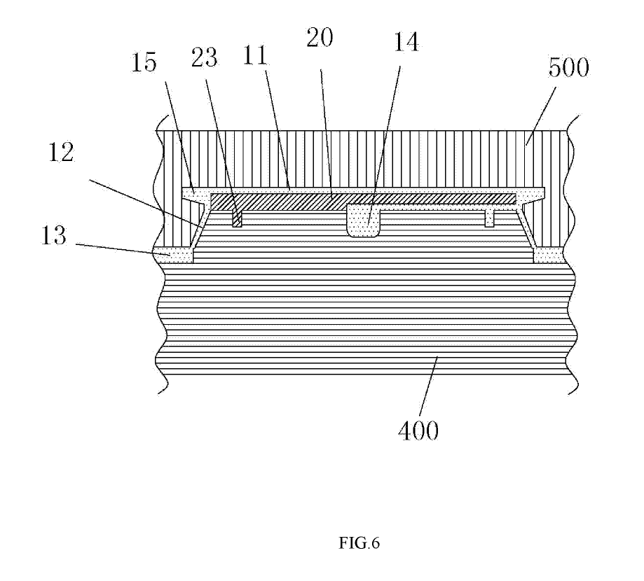

As shown in FIGS. 1-6, the present disclosure provides a keyboard with I-shaped key caps integrally formed by injection molding, the keyboard includes I-shaped key caps integrally formed 100, a printed circuit film 200 located under the I-shaped key caps integrally formed 100 and a keyboard base plate 300 for supporting the printed circuit film 200.

The integrated I-shaped key cap 100 is formed from soft rubber 10 and a plurality of hard sheets 20 by injection molding. Each hard sheet 20 corresponds to one key unit 100a; a concave body 21 which does not penetrate through the hard sheet 20 is formed in the center of the bottom surface of each hard sheet 20; a concave guide slot 22 which does not penetrate through the hard sheet 20 is formed on the edge of any side of the bottom surface of the hard sheet 20 and the concave guide slot 22 is communicated with the concave body 21. During injection molding with the soft rubber, the soft rubber 10 respectively forms a plurality of soft-rubber key surfaces 11, a plurality of soft-rubber key surface supporting bodies 12 and a soft-rubber supporting body base 13; the upper and lower ends of the key surface supporting body 12 are respectively connected with the soft-rubber surface and a key base 13 to form an integrated I-shaped soft-rubber entirety 100, and meanwhile, the soft rubber 10 is injected into the concave body 21 via the concave guide slot 22 to form a soft-rubber convex elastic switch body 14.

When the soft-rubber key surface 11 on the key unit 100a is pressed, a pressing force applied to the soft-rubber key surface 11 acts on the hard sheet 20, the hard sheet 20 transfers the pressing force to the soft-rubber convex elastic switch body 14, the soft-rubber supporting body is bent downward and vertically moves downward which makes the soft-rubber convex elastic switch body 14 vertically moves downward until clicking and contacting a corresponding circuit switching point on the printed circuit film 200 so that the switching circuit is closed and powered on.

When the finger leaves the soft-rubber key surface 11 of the key unit 100a, deformations of the soft-rubber convex elastic switch body 14 and the soft-rubber supporting body 12 are simultaneously recovered, the soft-rubber convex elastic switch body 14 is departed from the switching point of the corresponding switching circuit on the printed circuit film 200 so that the switching circuit is disconnected, and the integrated I-shaped key cap 100 is recovered to an original state.

The soft-rubber key surface 11 extends outwardly around all edges of the hard sheet 20 to form a T-shaped surface 15, and forms the integrated I-shaped key cap 100 together with the soft-rubber supporting body 12 and the soft-rubber base 13 by injection molding.

After assembling, all of the bottom surfaces 13a of various parts of the soft-rubber base 13 are bonded with corresponding positions of the printed circuit film 200 to form a whole body.

An edge at the bottom surface of the hard sheet 20 is provided with a downwardly protruded positioning ring 23 matched with a positioning groove 410 of a male mold 400.

The soft-rubber convex elastic switch body 14 is a cylinder which is integrally formed by injection molding and fitted to the concave body 21 of the bottom surface of the hard sheet 20, and the tail end of the cylinder right corresponds to the switching point of the printed circuit film 200.

The hard sheet 20 is a hard plastic sheet, or a metal sheet, or a glass sheet.

The soft rubber 10 is a soft rubber material such as acrylate rubber, silica gel rubber, TPR rubber, or PVC rubber.

The present disclosure provides a mold for integrally forming I-shaped key caps integrally formed by injection molding, including a male mold 400 and a female mold 500, wherein, the inner side surface of the bottom of the female mold 500 is provided with a circle of concave groove 510, the male mold 400 is provided with a key-unit injection molding boss 410 the center of which is provided with an injection molding shrinkage hole 411, and a positioning groove 412 for installation of the positioning ring 23 of the hard sheet is formed on an edge at the key-unit injection molding boss 410.

The present disclosure provides a production method with I-shaped key caps integrally formed by injection molding. A production device for the production method includes an injection machine, the male mold 400 and the female mold 500. The production method includes the following steps:

Step 1, during injection molding, all the hard sheets 20 are correspondingly put into corresponding key-unit injection molding bosses 410 on the male mold 400, and the positioning rings 23 of the bottom surfaces of the hard sheets 20 are inserted and positioned in the positioning grooves 412 on the key-unit injection molding bosses 410;

Step 2, after the female mold 500 is clamped on the male mold 400, soft rubber 10 is injected into mold cavities, the soft rubber 10 respectively forms a plurality of soft-rubber key surfaces 11, a plurality of soft-rubber key surface supporting bodies 12 and a soft-rubber base 13; meanwhile, the soft rubber 10 is injected into the injection molding shrinkage hole 411 of the key-unit injection molding boss 410 via the concave guide slot 22 of the hard sheet 20, and the soft rubber 10 in the injection molding shrinkage hole 411 is bonded to the concave body 21 of the hard sheet to form the soft-rubber convex elastic switch body 14;

Step 3, after the soft-rubber substance in the mold is solidified, the male mold 400 and the female mold 500 are opened, and the integrated key caps 100 which have been molded are ejected out one by one through a mold thimble.

During use, when the soft-rubber key surface 11 of the integrated key cap 100 is pressed, the soft-rubber key surface 11 downwardly moves along with downward bending of the soft-rubber supporting body 12. When in pressing the soft-rubber convex elastic switch body 14 can direct receive the pressing force transfer from the hard sheet 20, the soft-rubber convex elastic switch body 14 is downwardly pressed to contact a switching point of a corresponding switching circuit on the printed circuit film 200 so that the switching circuit is closed and powered on; meanwhile, the positioning ring 23 is vertically downward along with the soft-rubber convex elastic switch body 14. When the soft-rubber convex elastic switch body 14 moves to click and contact a switching point of a corresponding switching circuit on the printed circuit film 200, the circle of the bottom of the positioning ring 23 is steadily abutted against the printed circuit film 200, so that the key cap can keep balance when being pressed to the bottom, thereby taking an effect of smoothly pressing, overcoming the problem that the traditional key is uneven and easy to waggle when in pressing and improving the press hand feeling and balance. However, the pressing force transferred from the hard sheet 20 can achieve higher press precision, trepanning on the hard sheet 20 is avoided to perform integral injection molding of the soft-rubber convex elastic switch body 14, and the pressing force is generated when transfer is performed via the soft-rubber press surface 11 to cause the center of the soft-rubber press surface 11 to be protruded and deformed and is poor in pressing force.

When the soft-rubber key surface 11 is released, deformations of the soft-rubber convex elastic switch body 14 and the soft-rubber supporting body 12 are simultaneously recovered, the soft-rubber convex elastic switch body is departed from the switching point of the corresponding switching circuit, on the printed circuit film so that the switching circuit is disconnected, and the integrated I-shaped key cap 100 is recovered to an original state.

The above embodiments are some preferred embodiments disclosed by the present disclosure. In the present disclosure, the hemispheroidal soft-rubber convex elastic switch body can also be molded into shapes such as a cylinder, and simultaneously has a function of recovering press deformation and a function of the switching point of the corresponding switching circuit on the printed circuit film. All these switch bodies are included within the protective scope of the present disclosure.

I claim:

1. A keyboard with I-shaped key caps integrally formed by injection molding, comprising the I-shaped key caps integrally formed, a printed circuit film located under the I-shaped key caps integrally formed and a keyboard base plate for supporting the printed circuit film;
wherein, the I-shaped key caps are integrally formed from soft rubber and a plurality of hard sheets by injection molding, each hard sheet corresponds to one key unit; a concave body which does not penetrate through the hard sheet is formed in a center of a bottom surface of each hard sheet; a concave guide slot which does not penetrate through a surface of the hard sheet is formed on an edge at any side of the bottom surface of the hard sheet and the concave guide slot is communicated with the concave body; during injection molding with the soft rubber, the soft rubber respectively forms a plurality of soft-rubber key surfaces, a plurality of soft-rubber key surface supporting bodies and a soft-rubber supporting body base in a mold cavity; an upper end and a lower end of each key surface supporting body are respectively connected with one soft-rubber key surface and a key base to form an integrated I-shaped soft-rubber entirety, and meanwhile, the soft rubber is injected into the concave body via the concave guide slot to form a soft-rubber convex elastic switch body;
when the soft-rubber key surface on the key unit is pressed, a pressing force applied to the soft-rubber key surface acts on the hard sheet, the hard sheet transfers the pressing force to the soft-rubber convex elastic switch body, the soft-rubber supporting body is bent downward and vertically moves downward which makes the soft-rubber convex elastic switch body vertically moves downward until clicking and contacting a switching point of a corresponding switching circuit on the printed circuit film so that the switching circuit is closed and powered on;
when the soft-rubber key surface of the key unit is released, deformations of the soft-rubber convex elastic switch body and the soft-rubber supporting body are simultaneously recovered, the soft-rubber convex elastic switch body is departed from the switching point of the corresponding switching circuit on the printed circuit film so that the switching circuit is disconnected, and the integrated I-shaped key cap is recovered to an original state.

2. The keyboard according to claim 1, wherein, the soft-rubber key surface extends outwardly around all edges of the hard sheet to form a T-shaped surface, and forms the integrated I-shaped key cap together with the soft-rubber supporting body and the soft-rubber base by injection molding.

3. The keyboard according to claim 1, wherein, after assembling, a bottom surface of each part of the soft-rubber base is bonded with corresponding positions of the printed circuit film to form a whole body.

4. The keyboard according to claim 3, wherein, an edge at the bottom surface of the hard sheet is provided with a downwardly protruded positioning ring matched with a positioning groove of a male mold for injection molding.

5. The keyboard according to claim 4, wherein, the soft-rubber convex elastic switch body is a cylinder which is integrally formed by injection molding and fitted to the concave body at the bottom surface of the hard sheet, and a tail end of the cylinder right corresponds to the switching point of the printed circuit film.

6. The keyboard according to claim 4, wherein, the hard sheet is a hard plastic sheet, or a metal sheet, or a glass sheet.

7. The keyboard according to claim 4, wherein, the soft rubber is a soft rubber material including acrylate rubber, silica gel rubber, TPR rubber, or PVC rubber.

8. A mold for integrally forming the keyboard according to claim 1, comprising a male mold and a female mold, wherein, a circle of concave groove is defined on an inner side, surface at a bottom of the female mold, and a key-unit injection molding boss is defined on the male mold, an injection molding shrinkage hole is defined at a center of the key-unit injection molding boss.

9. The mold according to claim 8, wherein, a positioning groove for installation of a positioning ring of the hard sheet is formed on an edge at the key-unit injection molding boss.
